(19) United States
(12) Patent Application Publication
(10) Pub. No.: US 2018/0045275 A1
(43) Pub. Date: Feb. 15, 2018

(54) Drawstring Bag

(71) Applicant: VEPAK AS, Torondheim (NO)

(72) Inventor: Ole Jansen HOLTET, Trondheim (NO)

(21) Appl. No.: 15/553,721

(22) PCT Filed: Mar. 4, 2016
(86) PCT No.: PCT/EP2016/054700

§ 371 Date: Aug. 25, 2017

(30) Foreign Application Priority Data
Mar. 6, 2015 (GB) 1503819.3
Sep. 23, 2015 (GB) 1516855.2

(51) Int. Cl. F16G 11/10

(52) U.S. Cl. CPC F16G 11/106; A45C 13/1046

(57) ABSTRACT

A drawstring bag comprising: a bag; a drawstring encircling an open end of the bag; and a closure member comprising a sleeve and a plurality of angled teeth protruding within the interior of the sleeve, wherein: a portion of the drawstring comprising two co-extending lengths of drawstring extends from the bag; the closure member is located around the two co-extending lengths; and the angled teeth of the closure member allow the closure member to slide freely along the two co-extending lengths to close the bag, and engage with the drawstring to prevent the closure member from sliding in the opposite direction to re-open the bag, such that there cannot be movement of the closure member in the re-opening direction.

The present invention relates to a drawstring bag, which may for example be a drawstring bag for holding articles of any type typically packaged in bags, for example firewood, fruit or vegetables.

With any product sold commercially, it is important to be able to package the product in a manner that controls the packing volume. For loose articles this often means packing into a bag, such as a drawstring bag. It is an advantage to pack the products in a quick and automated fashion. This means that it is important to be able to both fill and close drawstring bags quickly and effectively. For example, PCT application PCT/EP2015/068768 discloses a machine for the quick and efficient packing of wood into bags. Other devices are used for packaging other articles, such as fruit and vegetables.

Generally, drawstring bags are closed by tying a knot in the drawstring to secure the drawstring in a knotted loop around the bag opening. However, this procedure is time consuming, particularly if the operator is wearing thick gloves (as may be that case, for example, when packing wood). The process of closing the drawstring bags then may become a limiting factor on the speed of the overall processing and packing operation, particularly if one operator is tasked with closing the bags for more than one packing machine.

As an alternative to knotting the drawstring in order to close the bags, a cord lock (also referred to as a cord fastener, or cord toggle) may be used. These generally consist of three parts: a barrel, a plunger and a spring. The barrel and plunger each include a through-hole, through which the drawstring passes. When the plunger is pushed into the barrel (against the force of the spring) the through-holes in the barrel and plunger align so that the drawstring can be pulled freely through the fastener. When the force on the plunger is released, the spring pushes the plunger away from the base of the barrel, such that the through-holes in the barrel and plunger are not aligned. The drawstring is then trapped between the barrel and plunger. Similar mechanisms also exist with a ratchet or slider to trap the drawstring when the bag is closed, where the drawstring is released when the ratchet or slider is moved away from the drawstring. EP 0227063 and U.S. Pat. No. 4,665,590 provide examples of such mechanisms.

Such cord locks allow the bag to be closed quickly and with relative ease (even when wearing gloves), but have the disadvantage that they are relatively costly, due to their rather complicated structure, and therefore increase the unit price of each bag. Costs are a significant driver in the sales of mass manufactured drawstring bags for single use such as packaging of wood or grocery products, and any increase in price is unlikely to be acceptable. These cord locks also require moving parts, which can in some cases be unreliable and often may be forced open if the cord is under sufficient tension.

Another alternative is the use of a friction mechanism where the drawstring is gripped in an orifice by ridges or the like, which act to give an increased resistance to motion of the drawstring in one direction compared to another. For example, U.S. Pat. No. 5,517,729 discloses a reusable closure device for drawstring bags with a ridged and tapering orifice that slides along the string relatively freely in one direction, but resists motion in the other direction. The drawstring is, necessarily, not entirely fixed in place and sufficient force will re-open the drawstring bag. This allows for reusability but reduces the effectiveness of closure device the drawstring. U.S. Pat. No. 4,896,403 discloses a clinch that uses ridged slots of tapering thickness extending perpendicular on either side of a passage for the drawstring. When the drawstring has been tightened then the two strings are pulled to either side to trap them in the slots, thereby resisting a reverse motion of the drawstrings. This provides an increased resistance to reverse motion than the arrangement of U.S. Pat. No. 5,517,729, but it also requires a more complicated manipulation of the strings to trap them.

Therefore, there is a need for a drawstring bag that can be securely closed quickly and easily, but is nevertheless inexpensive.

According to a first aspect of the invention, there is provided a drawstring bag comprising: a bag; a drawstring encircling an open end of the bag; and a closure member comprising a sleeve and a plurality of angled teeth protruding within the interior of the sleeve, wherein: a portion of the drawstring comprising two co-extending lengths of drawstring extends from the bag; the closure member is located around the two co-extending lengths; and the angled teeth of the closure member allow the closure member to slide freely along the two co-extending lengths to close the bag, and engage with the drawstring to prevent the closure member from sliding in the opposite direction to re-open the bag, such that there cannot be movement of the closure member in the re-opening direction.

Thus, it will be appreciated that this aspect of the invention provides a quick-lock closure for a drawstring bag, which is relatively inexpensive and which can be easily operated, even whilst wearing gloves. Unlike the prior art closure devices referenced above, the closure device of the first aspect cannot be released after it has been tightened. The inventor has made the non-obvious realisation that for many uses, in particular for single-use bags such as those used for packaging wood and grocery products, it is an unnecessary limitation on the design for the closure to be releasable. The need for a releasable closure means that the resistance to opening is reduced and/or that some complicated manipulation of the drawstring or the use of movable parts is required. The drawstring bag of the first aspect avoids these compromises. In fact, in most cases it is not possible to slide the closure member in the opening direction without some failure or damage to the structure of the closing mechanism or of the drawstring.

The requirement that the closure member is prevented from sliding and cannot move in the re-opening direction is intended to mean that, without some damage or failure of the closure member or the drawstring, no movement in the re-opening direction is possible. This is considerably different to prior art such as U.S. Pat. No. 4,896,403 or U.S. Pat. No. 5,517,729, where manipulation of the drawstring will release it from the clinch, or where a reversible movement simply requires increased force. Thus, the closure member of the first aspect can be characterised as a closure that may be non-reusable, or that closes irreversibly. The closure member may engage with the two lengths of the drawstring without any need for changes in direction or location of the drawstring, i.e. preferably the sliding of the drawstring along the length direction thereof will automatically engage the closure to create an irreversible closing of the drawstring bag. In some example implementations the teeth bite into the lengths of the drawstring, thus acting as barbs to prevent reverse movement. The teeth may hence pierce the material of the drawstring, for example by passing through openings in the weave of the drawstring.

Here, “drawstring” may be any string, rope, twine, band, cable, or tape etc., provided that the drawstring is capable of engagement with the angled teeth of the closure member. The drawstring may be a single element looped around the open end of the bag, with the two ends forming the co-extending lengths, or it may be in two parts with one part around a first half of the circumference of the open end, another part around a second half of the circumference of the open end, where one end of each part is secured to the bag and the other end of each part forms one of the two co-extending lengths.

Preferably, when the bag is open, the two co-extending lengths of drawstring have a length of 5 cm or more. That is, the portion of the drawstring which is gripped by the operator in order to close the bag protrudes by 5 cm or more from the bag. Preferably, the two co-extending lengths of drawstring have a length of 8 cm or more, more preferably 10 cm or more. Preferably the two co-extending lengths of drawstring have a length of 20 cm or less, more preferably 15 cm or less. A shorter drawstring reduces the unit cost of the bag, but if the portion of the drawstring which is gripped by the operator is too short, the bag will be more difficult to close.

The two co-extending lengths may be free ends or may be joined together at or near their ends furthest from the bag (for example by a knot, by stitching, by glue or by heat welding).

The drawstring may be woven or braided, or the like, as this allows for the teeth of the closure member to more securely grip the drawstring, for example by biting into the material of the drawstring. Thus, the material of the string may allow for penetration of the string by the teeth, either full or partial penetration. Preferably the drawstring must be able to hold the same when the teeth pierce it as when it is not pierced, which means that a woven material has advantages. Alternatively, the drawstring may have a rubberised or textured outer surface.

The bag may be a mesh (i.e. a net, or loose-weave) bag. In that case, the drawstring may be woven in and out of the meshes of the bag, in order to secure the drawstring around the open end of the bag. Alternatively, a seam can be formed around the top of the bag, and the drawstring can run through the seam, or loops can be added to the bag and the drawstring can be threaded through the loops.

The closure member may comprise two angled teeth. This is the preferred minimum required to grip the two co-extending lengths of drawstring. A greater number of teeth allows the drawstring to be more securely gripped. Therefore, more preferably, the closure comprises 4, 5, 6, 7, 8, 9, 10, 11 or 12 teeth. However, too many teeth increases the complexity of the closure, which undesirably increases the unit cost. Therefore, preferably, the closure comprises fewer than 20 angled teeth.

The angled teeth extend from the inner surface of the sleeve of the closure member at an acute angle, which is preferably an angle of less than 60°. For example an angle of about 15° may be used. The angled teeth may be angled at between 20° to 60° to the interior of the sleeve. Thus, the teeth may extend away from an interior surface of the sleeve at an angle of up to 60°, optionally above 20° forming an acute angle on one side of the teeth, facing toward the loose ends of the drawstring, and an obtuse angle on the other side of the teeth, facing toward the bag.

The angled teeth preferably have a tapered shape, wherein the teeth are wider at the end where they join the sleeve, and taper towards the distal end in the interior of the sleeve. The teeth preferably taper to a point.

The teeth are preferably angled so as to extend (from the wide end at which they join the sleeve towards the tapered distal end in the interior of the sleeve) in a direction opposite to the direction in which the closure member is moved to close the bag. As a result, the closure member is configured such that it can be readily slid along the two co-extending lengths of drawstring in the direction towards the bag, but cannot be slid in the opposite direction (i.e. towards the ends of the two co-extending lengths of drawstring). In use, the operator slides the closure member along the two co-extending lengths of the drawstring, and continues to do so, so that the open end of the bag is gathered up along the length of the drawstring. Eventually, this results in the open end of the bag being closed.

The drawstring may have a broadly circular cross-section, or may have a flat, tape-like cross-section. The closure member may have a substantially circular cross-section. Alternatively, the closure member may have a cross-section comprising two joined circles, each for receiving one of the two co-extending lengths of drawstring. In some examples, the closure member has an oval shaped cross-section. As the bag is closed, the part of the cord creating the locking loop will often be pulled to two separate opposite sides inside the lock, causing the cords to pull the lock bead into a position of maximum inner diameter in plane with the plane between the exiting parts of the draw strings. Preferably the angled teeth are provided about the entire inner circumference and advantageously in the area of maximum diameter. Thus, for example, the closure member may be an oval lock bead with teeth positioned in locations of the maximum inner diameter, or a circular lock bead with teeth spaced throughout the inner perimeter.

The closure member may have a cross-section comprising two substantially parallel sides (which are substantially parallel to the flat surfaces of the tape-like drawstring), with the angled teeth protruding from each of the parallel sides to face each other. In this case the drawstring is preferably arranged so that one of the two co-extending lengths of drawstring lies on top of the other, and both are sandwiched between the angled teeth. Avoiding a fully circular cross-section may provide an advantage for flat tapes because the two lengths of tape in a round closure member may be able to roll together, one inside the other, such that only the outer tape is gripped by the angled teeth of the closure member, and the inner tape is free to move. The best shape of cross-section for the closure member may depend on the nature of the drawstrings as well as how full the bag will be, in use, and the size and direction of forces that will be applied to the drawstrings when the closure member is in the closed position.

The distance between the two parallel sides, and/or the length of the angled teeth, may be chosen appropriately depending on the thickness of the drawstring, to ensure that the angled teeth from each side will bite into one or both of the two co-extending lengths of drawstring. Preferably, the distal ends of the angled teeth in the interior of the sleeve (preferably which are pointed ends) are located approximately along a line lying parallel to the two parallel sides, and half-way between the two parallel sides. This is the line along which the two co-extending lengths of drawstring lie. The angled teeth extending from one of the two parallel sides are slightly offset along this line from the angled teeth extending from the other of the two parallel sides. This arrangement has been found to allow the closure member to be easily slid along the drawstring in the direction towards the bag, but nevertheless results in the drawstring being held securely by the teeth when an attempt is made to slide the closure member in the opposite direction (i.e. towards the ends of the two co-extending lengths of drawstring).

The same number of angled teeth may extend from a first one of the two parallel sides as extend from the other of the two parallel sides. Alternatively, a different number of teeth may extend from the two parallel sides.

The width of the parallel sides may be determined by the width of the drawstring tape to be threaded through. Preferably, the width of the parallel sides is as wide as, or wider than, the width of the drawstring tape to be threaded through.

The two parallel sides may be joined by semicircles at either end (i.e. forming a stadium- or obround-shaped cross-section), or may be joined by two further straight and parallel sides (i.e. forming a square, rectangular or parallelogram cross-section). The former is preferred, since this allows the closure member to be gripped easily, and the absence of any sharp edges reduces the risk of injury to the operator (especially if the number of bags to be closed is very high).

With a closure member having an oval cross-section the outer oval ring may have a varying depth such that it is thinner at the two open ends and thicker at the mid-length in order to produce a bulging profile along the axis of the closure member. This creates a more ergonomic shape.

The closure member is preferably made from plastic, for example polyoxymethylene (POM), or polyvinylchloride (PVC).

The drawstring bag described above in the aspect and in the optional features there of is advantageous in any situation where it is desirable to be able to close and lock bags quickly and easily. This includes packing of wood, for example as produced on an automated machine for packing fire wood, and it also includes packing of fruit and vegetables, for example onions, potatoes, apples and so on, which are commonly supplied in drawstring bags. The same applies to other articles that are suitable for packing into drawstring bags.

### BRIEF DESCRIPTION OF THE DRAWINGS

Certain preferred embodiments of the invention will now be described by way of example only and with reference to the accompanying drawings, in which:

FIG. 1 shows a drawstring bag for receiving the bundle of wood;

FIG. 2 shows a view of the closure member looking along the length of the sleeve of the closure member;

FIG. 3 shows a cross-section of the closure member; and

FIG. 4 shows a perspective cross-section of the closure member with the two co-extending lengths of drawstring which extend from the bag threaded there-through.

FIG. 5 shows an alternative closure member.

FIG. 6 shows another perspective of the alternative closure member.

FIG. 7 shows yet another perspective of the alternative closure member.

### DETAILED DESCRIPTION OF THE INVENTION

FIG. 1 shows a drawstring bag 100 for receiving articles such as a bundle of wood. The bag 100 comprises a drawstring 104 encircling the open end 102 of the bag. The bag 100 is a mesh bag, i.e. made of a loosely woven material, and so the drawstring 104 is woven in and out of the mesh at the open end 102 of the bag 100 in order to secure the drawstring 104 to the bag 100.

The drawstring 104 in this example is a woven plastic tape (i.e. having a flat cross-section). A portion 106 of the drawstring 104 extends outwardly of the side of the bag 100. The portion 106 of the drawstring 104 comprises two co-extending lengths 108 of drawstring 104. In this example, the two co-extending lengths 108 are knotted together at their ends furthest from the bag. The portion 106 of the drawstring 104 extends from the point where the two co-extending lengths 108 exit the bag to the ends of the co-extending lengths 108 furthest from the bag. The portion 106 of the drawstring 104 extends by 10 cm from the side of the bag, thereby providing a sufficient length of drawstring 104 for the operator to grip.

A plastic closure member 110 is provided with a sleeve of the closure member 110 surrounding the two co-extending lengths 108 of drawstring 104 along the length of the portion 106 of the drawstring 104 extending from the side of the bag. The closure member is simply slid onto the two co-extending lengths 108 of drawstring 104 before the two co-extending lengths 108 are (optionally) knotted together. The closure member is configured such that it can be readily slid along the two co-extending lengths 108 of drawstring 104 in the direction towards the bag 100, but it cannot be slid in the opposite direction (i.e. towards the ends of the two co-extending lengths 108 of drawstring 104).

The portion 106 of the drawstring 104 comprises a first section 106a which extends from the point where the two co-extending lengths 108 exit the bag to the closure member 110, and a second section 106b which extends from the closure member 110 to the ends of the co-extending lengths 108 furthest from the bag. In use, the operator grips the second section 106b and slides the closure member 110 along the first section 106a of the two co-extending lengths 108 of drawstring, and continues to do so, so that the open end 102 of the bag 100 is gathered up along the length of the drawstring 104. Eventually, this results in the open end 102 of the bag 100 being closed. As the closure member 110 cannot be slid in the opposite direction (which, if possible, would allow the bag to be reopened), the drawstring bag 100 is locked closed. Alternatively, to close the bag, the operator grips the closure member 110 and pulls the second section 106b to pull the drawstring 104 through the closure member 110, which has the same effect.

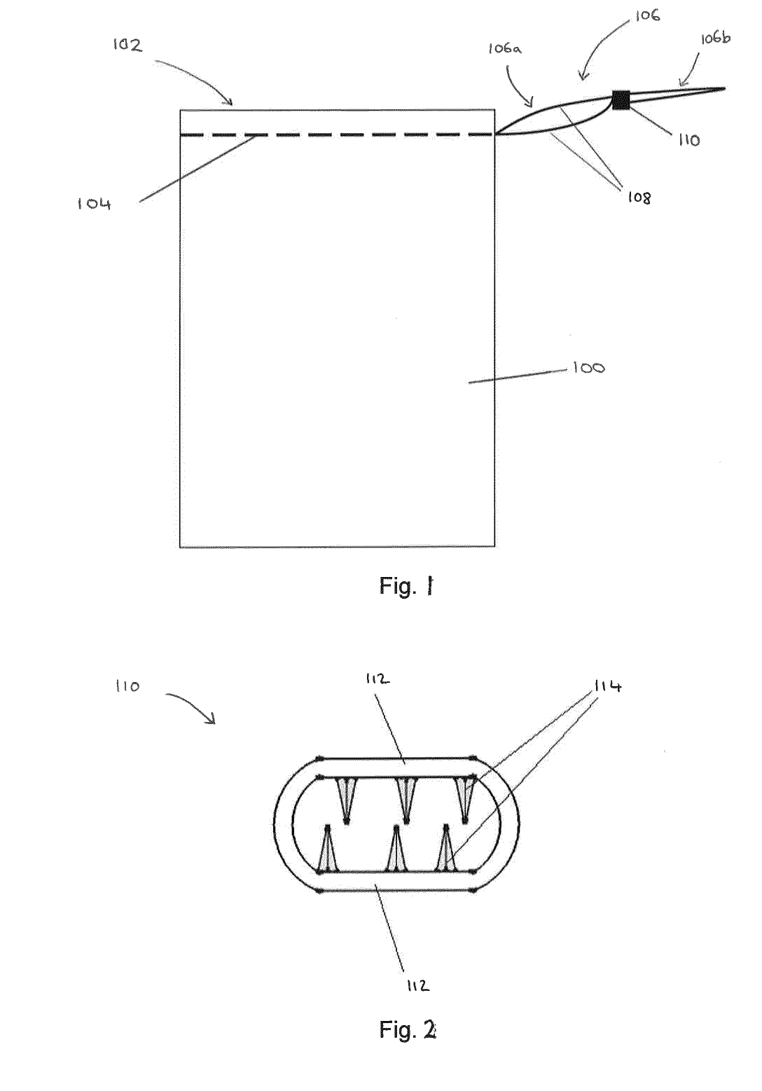

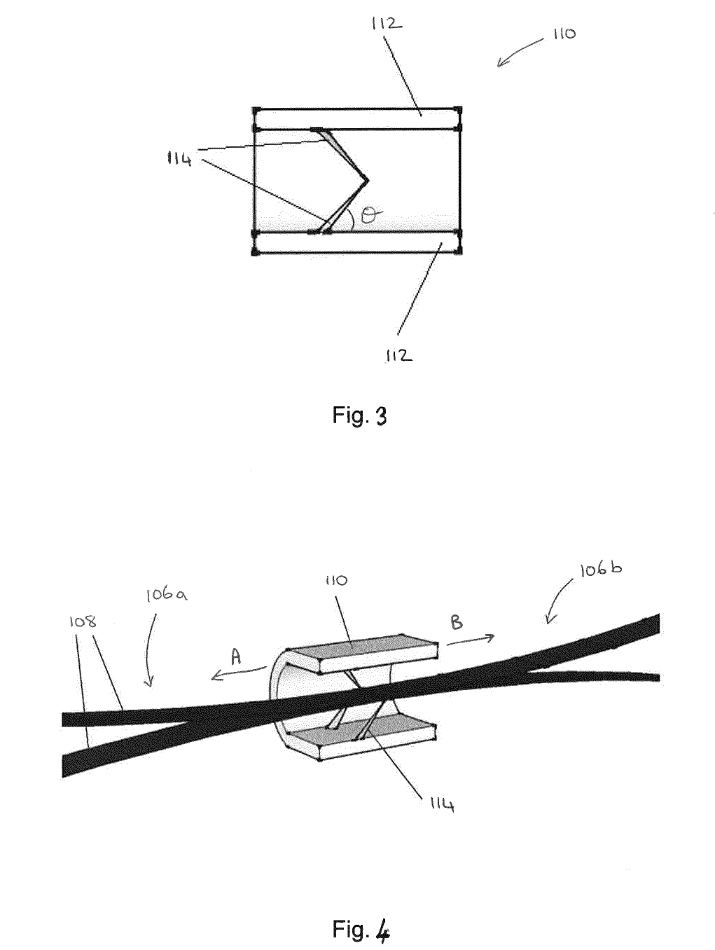

A first example of a closure member is shown in FIGS. 2 to 4. FIG. 2 shows a view of the closure member looking along the length of the sleeve of the closure member 110, FIG. 3 shows a cross-section of the closure member 110; and FIG. 4 shows a perspective cross-section of the closure member 110 with the two co-extending lengths 108 of drawstring 104 which extend from the bag 100 threaded there-through.

As is clear from these figures, the closure member 110 comprises a sleeve and a plurality of angled teeth 114 (in this case, six angled teeth) protruding within the interior of the sleeve. The angled teeth 114 have a tapered shape, wherein the teeth are wider at the end where they join the sleeve, and taper towards the distal end in the interior of the sleeve. The angled teeth 114 taper to a point, and so have a shark-tooth-like shape.

The angled teeth 114 allow the closure member 110 to slide freely along the two co-extending lengths 108 to close the bag, and engage with the drawstring 104 to prevent the closure member from sliding in the opposite direction to re-open the bag 100. In particular, as shown in FIG. 4, the closure member 110 can move in the direction labelled by the arrow A relative to the drawstring 104, but cannot move in the direction labelled by the arrow B. If an attempt is made to move the closure member 110 in the direction labelled by the arrow B, then the angled teeth 114 bite into the drawstring 104 and prevent further movement. That is, the angled teeth 114 are angled so as to extend (from the point at which the tooth joins the sleeve to the distal pointed end of the tooth in the interior of the sleeve) in a direction opposite to the direction in which the closure member is moved to close the drawstring bag 100.

The closure member 110 has a cross-section comprising two substantially parallel sides 112 (which are substantially parallel to the flat surfaces of the tape-like drawstring 104), with the angled teeth 114 protruding from each of the parallel sides 112 to face each other. This is best shown in FIG. 3. The drawstring 104 is arranged so that one of the two co-extending lengths 108 of drawstring 104 lies on top of the other (see FIG. 4), and both are sandwiched between the angled teeth 114.

The distance between the two parallel sides 112 and the length of the angled teeth 114 are chosen appropriately depending on the thickness of the drawstring 104, to ensure that the angled teeth 114 from each side 112 will bite into one or both of the two co-extending lengths 108 of drawstring 104. In the closure member 110 shown in FIGS. 1 to 4, the distance between the two parallel sides 112 is about 5 mm. The angled teeth have a length (from the point at which the tooth 114 joins the sleeve to the tip of the tooth) of about 5 mm, and the angle at which the tooth 114 extends from the sleeve is about 30° (the relevant angle is labelled θ in FIG. 3, and it is not shown to scale). Therefore the points of the angled teeth 114 are located along a line lying parallel to the two parallel sides, and approximately half-way between the two parallel sides 112. This is the line along which the two co-extending lengths 108 of drawstring 104 lie. As is clear from FIG. 2, the three angled teeth 114 extending from one of the two parallel sides 112 are slightly offset along this line from the three angled teeth 114 extending from the other of the two parallel sides 112. It will be appreciated that the angle of the teeth 114 could vary, provided it is sufficiently acute to ensure that the teeth bite into the drawstring 108 and engage with it to prevent reverse motion of the closure member 110 along the drawstring 108.

The width of the parallel sides 112 is such that the drawstring tape 104 may be readily threaded through, without needing to fold or crease the tape. That is, the width of the parallel sides 112 is as wide, or wider than, the width of the drawstring tape 104. In the closure member 110 shown in FIGS. 1 to 4, the width of the drawstring tape 104 and the width of the parallel sides 112 each equal about 1 cm.

The two parallel sides 112 are joined by semicircles at either end (i.e. forming a stadium- or obround-shaped cross-section). This allows the closure member 110 to be gripped easily, and the absence of any sharp edges reduces the risk of injury to the operator (especially if the number of bags to be closed is very high).

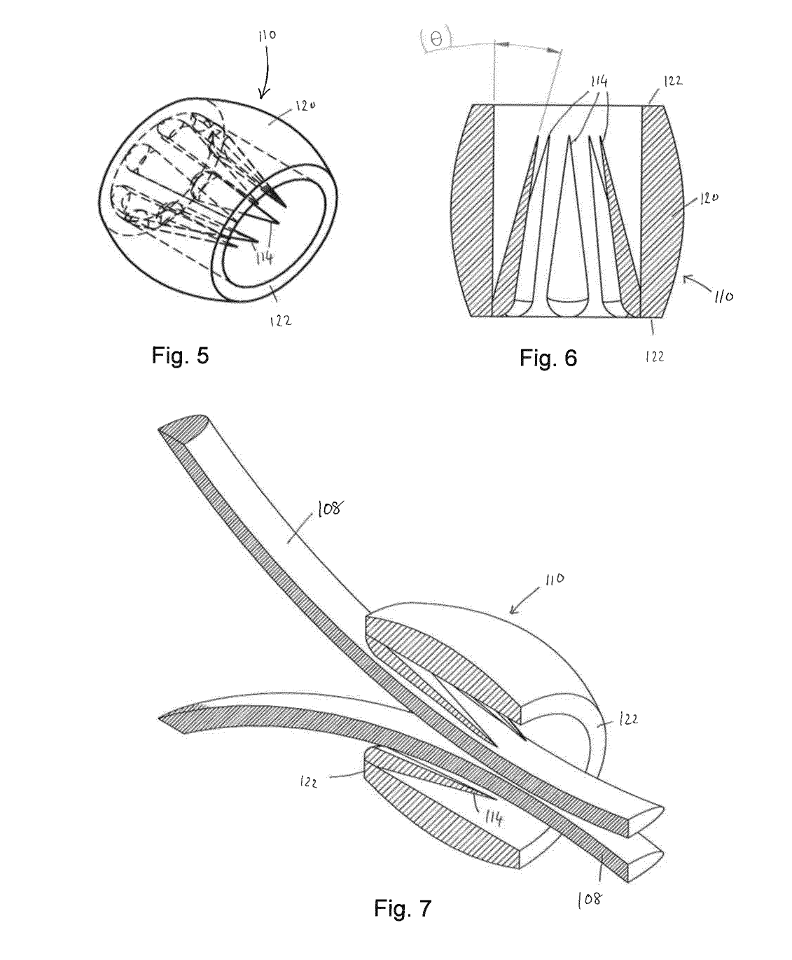

FIGS. 5 to 7 show an alternative closure member 110. This closure member 110 can be used with a drawstring bag 100 as shown in FIG. 1 in the same way as the closure member of FIGS. 2 to 4. The closure member 110 of FIGS. 5 to 7 differs from the closure member one 110 of FIGS. 2 to 4 mainly in the shape of the cross-section and the form of the outer body portion that supports the angled teeth 114. The angled teeth 114 interact with the drawstring 108 in a broadly similar manner to the angled teeth 114 of the earlier example, biting into and piercing the material of the drawstring 108 when the closure member 110 is pushed backward along the drawstring 108, but allowing free movement forward along the drawstring 108 to close the drawstring bag 100. In this example there are eight teeth and the angle of the teeth is typically about 15-25°, although alternative angles could be used. The teeth 114 have a similar tapering shape to that described above.

The outer body portion of the closure member 110 in this example has an oval shape with a thicker profile at the mid-length 120 and a thinner profile at the open ends 122. This shape is easy to grip and can be readily grasped and slid along the drawstring 108 to close the bag 100, even if the user is wearing gloves. The angled teeth 114 will engage with the material of the drawstring 108 to prevent any reverse movement, so that the closure member 110 cannot be removed without breaking either the drawstring 108 or the angled teeth 114. Thus, there is a very secure and irreversible closing of the drawstring bag 100.

The bag 100 with the closure member 110 has benefits for any use where it is required to quickly secure articles in a drawstring bag, for example for loose articles sold in packages of multiple articles. The bag has a quick and lockable closure mechanism and can be used to speed up packing of materials of any type when it is desirable to close the bag securely. The same bags could be used for manual packing of wood or for packing other materials such as fruit or vegetables.

1. A drawstring bag comprising:
a bag;
a drawstring encircling an open end of the bag; and
a closure member comprising a sleeve and a plurality of angled teeth protruding within an interior of the sleeve, wherein:
a portion of the drawstring comprising two co-extending lengths of the drawstring extends from the bag;
the closure member is located around the two co-extending lengths; and
the angled teeth of the closure member allow the closure member to slide freely along the two co-extending lengths to close the bag, and engage with the drawstring to prevent the closure member from sliding in an opposite direction to re-open the bag, such that there cannot be movement of the closure member in a re-opening direction.

2. A drawstring bag according to claim 1, wherein the angled teeth are angled at between 15° to 60° to the interior of the sleeve.

3. A drawstring bag according to claim 1, wherein the angled teeth have a tapered shape such that they are wider at an end where they join the sleeve, and taper towards a distal end in the interior of the sleeve.

4. A drawstring bag according to claim 1, wherein the closure member comprises between 4 and 12 angled teeth.

5. A drawstring bag according to claim 1, wherein, when the bag is in an unclosed state, the two co-extending lengths of the drawstring have a length of 5 cm or more, or the two co-extending lengths of the drawstring have a length of 20 cm or less.

6. A drawstring bag according to claim 1, wherein the drawstring is woven or braided or comprises a rubberised or textured outer surface.

7. A drawstring bag according to claim 1, wherein the drawstring has a circular cross-section.

8. A drawstring bag according to claim 7, wherein the closure member has a circular cross-section, an oval cross-section, or a cross-section comprising two joined circles, each for receiving one of the two co-extending lengths of drawstring.

9. A drawstring bag according to claim 1, wherein the drawstring has a flat, tape-like cross-section.

10. A drawstring bag according to claim 9, wherein the closure member has a cross-section comprising two substantially parallel sides, with the angled teeth protruding from each of the parallel sides to face each other.

11. A drawstring bag according to claim 10, wherein the drawstring is arranged so that one of the two co-extending lengths of the drawstring lies on top of the other, and both are sandwiched between the angled teeth.

12. A drawstring bag according to claim 1, wherein the angled teeth are configured to bite into one or both of the two co-extending lengths of the drawstring.

13. A drawstring bag according to claim 1, wherein the drawstring bag is a mesh bag, and the drawstring is woven in and out of meshes of the bag, in order to secure the drawstring around an open end of the bag.

14. (canceled)

15. The drawstring bag according to claim 3, wherein the angled teeth taper to a point.

16. The drawstring bag according to claim 1, wherein, when the bag is in an unclosed state, the two co-extending lengths of the drawstring have a length of 8 cm or more.

17. The drawstring bag according to claim 1, wherein, when the bag is in an unclosed state, the two co-extending lengths of the drawstring have a length of 10 cm or more.

18. The drawstring bag according to claim 1, wherein, when the bag is in an unclosed state, the two co-extending lengths of the drawstring have a length of 15 cm or less.
